(19) United States
(12) Patent Application Publication
(10) Pub. No.: US 2013/0129357 A1
(43) Pub. Date: May 23, 2013

(54) APPARATUS, SYSTEM, AND METHOD FOR CONTROLLED INFRARED ILLUMINATOR

(71) Applicant: Design Criteria, Inc., Roy, UT (US)

(72) Inventors: Carl I. Belnap, Roy, UT (US); Lamont P. Dean, Roy, UT (US)

(73) Assignee: DESIGN CRITERIA, INC., Roy, UT (US)

(21) Appl. No.: 13/632,942

(22) Filed: Oct. 1, 2012

Related U.S. Application Data
(60) Provisional application No. 61/541,829, filed on Sep. 30, 2011.

(51) Int. Cl. B64C 19/00

(52) U.S. Cl. CPC B64C 19/00
USPC 398/106

(57) ABSTRACT

An apparatus for a controlled infrared illuminator includes an unmanned aerial system capable of sustained flight and an infrared light source coupled to the unmanned aerial system by attachment means. The infrared light source includes a plurality of laser diodes arranged in a pattern. The apparatus also includes a remote control that controls either the movements of the unmanned aerial system, the position of the infrared light source, or both.

### CROSS-REFERENCES TO RELATED APPLICATIONS

This application claims the benefit of U.S. Provisional Patent Application No. 61/541,829 entitled “Controlled Infrared Illuminator” and filed on Sep. 30, 2011 for Carl I. Belnap, which is incorporated herein by reference.

### FIELD

The subject matter disclosed herein relates to a controlled infrared illuminator and more particularly relates to an infrared light source coupled to a remote-controlled unmanned aerial system.

### BACKGROUND

### Description of the Related Art

Various types of night vision equipment require infrared light in order to operate effectively. In certain situations, the environment provides insufficient levels of infrared light for optimal use of night vision equipment. Flares are typically used to provide the necessary infrared light in these situations. For example, an M278 flare may be launched from an aircraft or rocket launcher with a parachute. When the flare is launched, it burns for approximately three minutes, providing 2K candle power of visible light with an illumination diameter of 4,700 feet at a height of 3,000 feet. The illumination diameter, however, diminishes during the three minute operation time. Flares of this type typically suffer from a pendulum swing effect, which decreases its usefulness. Moreover, such flares are difficult to position and are only good for one-time use.

Similarly, electronic infrared flares, which utilize light emitting diodes (“LED”s) or laser diodes to provide the infrared light, may also be provided. These electronic infrared flares, however, are generally only for one-time use. Additionally, electronic infrared flares are deployed with a parachute, similar to some traditional flares, which may cause the electronic infrared flare to suffer from the pendulum effect and can be difficult to position, thus decreasing their effectiveness in practical situations.

### SUMMARY

From the foregoing discussion, it should be apparent that a need exists for an apparatus, system, and method that provide controlled infrared illumination. Beneficially, such an apparatus, system, and method would provide a more reliable infrared illumination system that may be remotely manipulated by a remote control.

The present invention has been developed in response to the present state of the art, and in particular, in response to the problems and needs in the art that have not yet been fully solved by currently available infrared illumination systems. Accordingly, the present invention has been developed to provide an apparatus, system, and method for providing an unmanned aerial system (“UAS”) with an accompanying infrared light source to deliver a more controlled infrared light source that overcomes many or all of the above-discussed shortcomings in the art.

The apparatus, in one embodiment, includes a UAS that is capable of sustained periods of flight and an infrared light source, which, in some embodiments, is coupled to the UAS by attachment means. In one embodiment, the movements of the UAS and/or the position of the infrared light source are directed by a remote control. In some embodiments, a control signal may be provided, which is configured to receive, translate, and transmit one or more signals from the remote control to the infrared light source. The apparatus, in one embodiment, includes a battery pack that provides power to the infrared light source by providing a regulated direct current (“DC”). The infrared light source, in one embodiment, includes a DC to DC converter, which receives a DC voltage from the battery pack and provides a regulated DC voltage to the infrared light source.

The remote control, in one embodiment, adjusts the intensity of the infrared light source and/or the width of the infrared light source beam. The remote control may also turn the infrared light source on and off in certain embodiments. Further, the infrared light source, in one embodiment, provides infrared light within the near- and mid-portions of the infrared light spectrum and may include a plurality of laser diodes arranged in a pattern. In one embodiment, subsets of the laser diodes are configured to alternately turn on and off such that the infrared light source processes more than one phase change. In certain embodiments, the phase change is controlled by at least one driver where each driver controls at least one laser diode.

A system of the present invention is also presented to provide a more controlled infrared illuminator. In particular, the system, in one embodiment, includes a UAS capable of sustained periods of flight and an infrared light source that is coupled to the UAS by attachment means. In certain embodiments, a remote control is provided, which controls the movements of the UAS and/or the position of the infrared light source. Also provided, in some embodiments, is a battery pack configured to provide a regulated DC output to power the infrared light source. In some embodiments, a control signal may be provided, which is configured to receive, translate, and transmit one or more signals from the remote control to the infrared light source.

The remote control, in one embodiment, adjusts the intensity of the infrared light source and/or the width of the infrared light source beam. The remote control may also turn the infrared light source on and off in certain embodiments. Further, the infrared light source, in one embodiment, provides infrared light within the near- and mid-portions of the infrared light spectrum and may include a plurality of laser diodes arranged in a pattern. In one embodiment, subsets of the laser diodes are configured to alternately turn on and off such that the infrared light source processes more than one phase change. In certain embodiments, the phase change is controlled by at least one driver where each driver controls at least one laser diode.

A method of the present invention is also presented for providing a more controlled infrared illuminator. The method in the disclosed embodiments substantially includes the steps necessary to carry out the functions presented above with respect to the operation of the described apparatus and system. In one embodiment, the method includes providing a UAS capable of sustained flight and coupling an infrared light source to the UAS by attachment means. In one embodiment, the method includes controlling the movements of the UAS and/or controlling the position of the infrared light source using a remote control.

The method, in other embodiments, may include providing a battery pack to provide power to the infrared light source by providing a regulated direct current. In one embodiment, a DC to DC converter is used to receive a DC voltage from the battery pack and provide a regulated DC voltage to the infrared light source. The infrared light source, in one embodiment, provides infrared light within the near- and mid-portions of the infrared light spectrum. Further, in certain embodiments, the remote control adjusts the intensity of the infrared light source and/or the width of the infrared light source beam. The remote control may also turn the infrared light source on and off in certain embodiments

References throughout this specification to features, advantages, or similar language do not imply that all of the features and advantages may be realized in any single embodiment. Rather, language referring to the features and advantages is understood to mean that a specific feature, advantage, or characteristic is included in at least one embodiment. Thus, discussion of the features and advantages, and similar language, throughout this specification may, but do not necessarily, refer to the same embodiment.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a system comprising a UAS, an infrared light source, a UAS remote control, and an infrared light source remote control;

FIG. 2 illustrates one embodiment of an infrared light source that includes laser diodes;

FIG. 3 is a schematic block diagram illustrating one embodiment of a circuit of an infrared light source;

FIG. 4 is a circuit schematic illustrating one embodiment of one half of a drive circuit;

FIG. 5 is a circuit schematic illustrating one embodiment of the second half of the drive circuit shown in FIG. 4;

FIG. 6 is a circuit schematic illustrating one embodiment of a DC-DC converter and power supply circuit;

FIG. 7 is a circuit schematic illustrating one embodiment of sets of laser diodes; and

FIG. 8 is a circuit schematic illustrating one embodiment of a set of laser diodes.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++ or the like and conventional procedural programming languages, such as the C programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. These computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

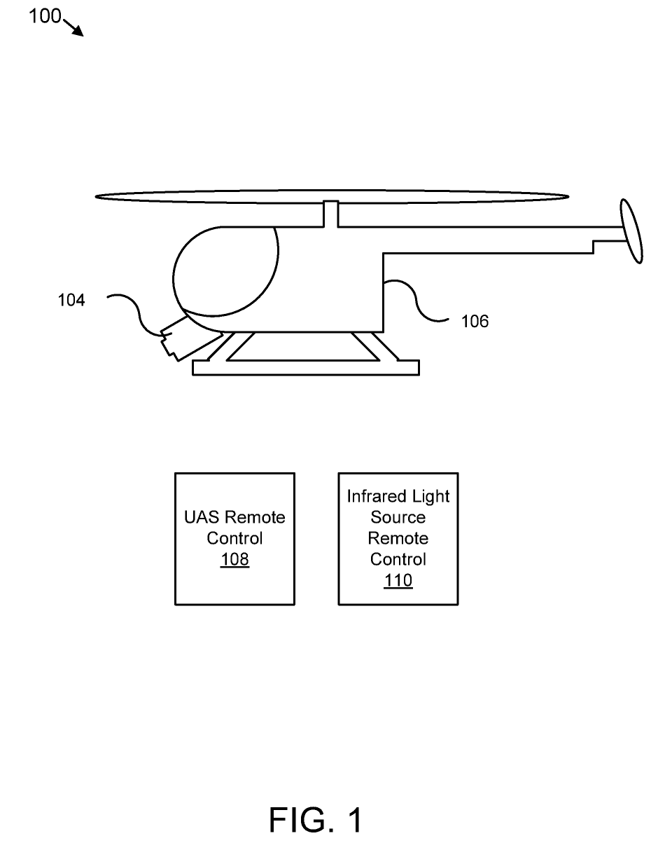

FIG. 1 depicts one embodiment of a system 100 including an unmanned aerial system (“UAS”) 106 with an infrared light source 104. The term UAS, as used herein, refers to a vehicle that is not operated by a human within the vehicle and that is capable of periods of sustained flight. The UAS 106 may be operated in flight by a human via a remote control, a computer, or some combination thereof. In one embodiment, the UAS 106 is a remote-controlled helicopter. In other embodiments, the UAS 106 is a remote-controlled airplane. In another embodiment, the UAS 106 is a remote-controlled blimp. Other appropriate UAS 106 may also be used.

The system 100 may also include a UAS remote control 108. The UAS remote control 108 allows a user to direct the flight of the UAS 106 by controlling the movements of the UAS 106. The UAS remote control 108 may be a standalone piece of hardware, a laptop computer, or other device capable of sending and receiving signals from the UAS 106. A user may control the position of the UAS 106 using the UAS remote control 108. In one embodiment, the UAS remote control 108 is a standard remote control with a pair of joysticks for controlling flight. The UAS remote control 108 may also include other input mechanisms. The UAS remote control 108 may also have other appropriate configurations.

The system 100 may also include an infrared light source 104 attached to the UAS 106. As used herein, an infrared light source 104 is a light source that emits light, the majority of which is within the infrared portion of the electromagnetic spectrum. In certain embodiments, the infrared light source 104 provides light within the near infrared portion of the infrared spectrum (with wavelengths ranging from approximately 0.7 to 1.3 microns). In other embodiments, the infrared light source 104 may provide light within the mid infrared portion of the infrared spectrum (with wavelengths ranging from approximately 1.3 to 3 microns). In certain embodiments, the infrared light source 104 provides light within one or both of the near-infrared and mid-infrared portions of the infrared spectrum, but not the thermal-infrared portion of the infrared spectrum.

As explained above, the infrared light source 104 provides infrared light when activated. In certain embodiments, the infrared light source 104 is a separate unit that is mounted onto the UAS 106. The infrared light source 104 may, for example, be mounted on an underbelly of the UAS 106. The infrared light source 104 may alternatively be front mounted on the UAS 106. In certain embodiments, the infrared light source 104 is built into the chassis of the UAS 106. The infrared light source 104 mounted into the chassis of the UAS 106 may also be designed to be removable from the chassis by a user in order to allow the user to service or maintain the infrared light source 104.

In certain embodiments, the system 100 includes an infrared light source remote control 110. The infrared light source remote control 110 may be used to remotely direct the position of the infrared light source 104. The infrared light source 104 may be mounted to a controller that receives signals from the infrared light source remote control 110 and responds by changing the position of the infrared light source 104 according to the signals received. For example, a user may desire to direct the infrared light source 104 towards a particular area on the ground without moving the UAS 106. The user may provide information to the infrared light source remote control 110 indicating the desired change in position, and the infrared light source 104 may respond by changing its position accordingly.

In certain embodiments, the user may also adjust the intensity of the infrared light source 104 from the infrared light source remote control 110. The infrared light source remote control 110 may also allow the user to turn on and turn off the infrared light source 104, thereby controlling whether the infrared light source 104 provides infrared light or not.

In one embodiment, the UAS remote control 108 and the infrared light source remote control 110 are part of the same physical device. The infrared light source remote control 110 may use auxiliary control switches in the UAS remote control 108. In other embodiments, the UAS remote control 108 and the infrared light source remote control 110 are separate physical devices.

The infrared light source remote control 110 may receive directional information from the user through a control such as a joystick. The user, by moving the joystick on the infrared light source remote control 110, may cause a corresponding change in the position of the infrared light source 104. In other embodiments, the user provides directional information by entering information (such as numbers) on a keyboard. Other approaches for providing directional information to the infrared light source remote control 110 that indicate how to change the position of the infrared light source 104 may also be used.

While the UAS 106 may be equipped with an infrared light source 104, in certain embodiments, the UAS 106 is not equipped with an infrared camera or other equipment for receiving and responding to an infrared signal. Such equipment may be unnecessary as the UAS 106 and the infrared light source 104 are necessary only to provide the infrared light source 104 for persons equipped with night vision goggles, or other persons or equipment that have need of infrared light to operate.

In certain embodiments, the infrared light source 104 is situated on the UAS 106 such that the infrared light source 104 directs the infrared light below the body of the UAS 106. The infrared light source 104 may be configured to provide a wide beam of infrared light, as opposed to a narrow beam, in order to provide greater coverage of the ground or other areas.

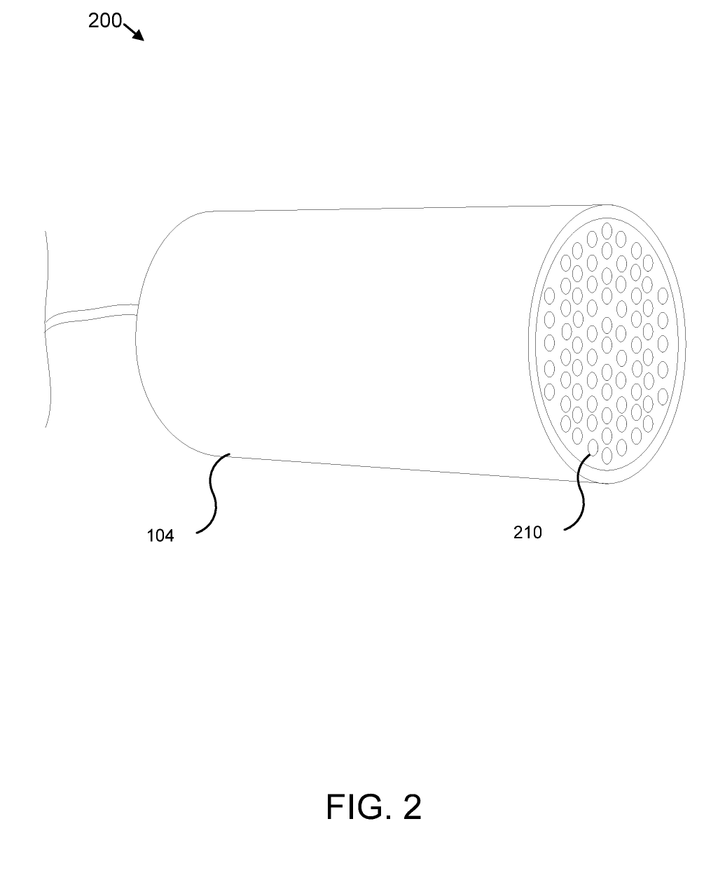

FIG. 2 shows one embodiment 200 of an infrared light source 104. The embodiment shown in FIG. 2 is one example of a suitable infrared light source 104; other configurations may also be suitable. The infrared light source 104 includes a plurality of laser diodes 210 that provide the infrared light. The laser diodes 210 may be made using materials having a direct band gap with energies corresponding to infrared light such that the laser diodes 210 emit infrared light when the infrared light source 104 is on.

The infrared light source 104 may include multiple laser diodes 210, as seen in FIG. 2. In one embodiment, the infrared light source 104 includes between 80 and 100 laser diodes 210. The laser diodes 210 may be arranged in any appropriate pattern or shape. In certain embodiments, not all laser diodes 210 are activated simultaneously when the infrared light source 104 is turned on. Groups of laser diodes 210 that are a subset of the set of laser diodes 210 may be formed. The infrared light source 104 may activate a first group of laser diodes 210 during a first phase, a second group of laser diodes 210 containing laser diodes 210 separate from the first group of laser diodes 210 during a second phase, and so on. In one embodiment, the infrared light source 104 moves through 16 phases, activating distinct groups of laser diodes 210 during each phase. In one embodiment, the phases change at a rate of approximately 160 kHz.

The infrared light source 104 may include a protective casing to provide structure and protection to the laser diodes 210 and the circuitry contained within the infrared light source 104. The infrared light source 104 may obtain power from a power source, such as a rechargeable battery, within the protective casing. In other embodiments, the power source is located externally from the infrared light source 104.

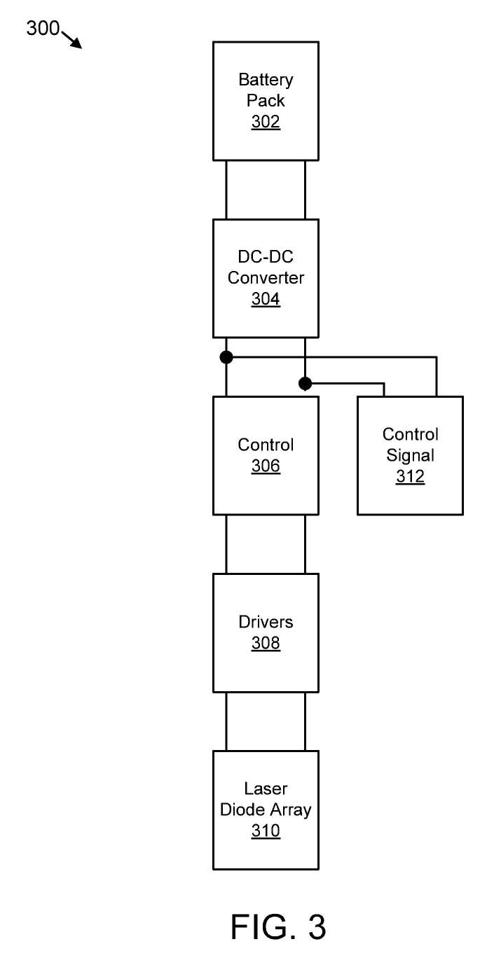

FIG. 3 is a schematic block diagram 300 illustrating one embodiment of an infrared light source 104. The infrared light source 104 may include a battery pack 302. Any appropriate battery technology may be used. In one embodiment, the battery pack 302 provides a regulated direct current (DC) 9-volt output. The infrared light source 104 may also include a DC-DC converter 304. The DC-DC converter 304 receives a DC input voltage from the battery pack 302 and provides a regulated DC output voltage to the control 306. In one embodiment, the DC-DC converter 304 is a boost topology that boosts a 9 Volt input voltage to a 30 Volt output voltage. In certain embodiments, the output voltage is adjustable and can be raised and lowered based on the power needs of the infrared light source 104. The output voltage of the DC-DC converter 304 may be controlled remotely by an individual or machine controlling the UAS 106.

The infrared light source 104 may also include a control signal 312. The control signal 312 receives signals from the infrared light source remote control 110 and translates them to signals that can be read, interpreted, and acted upon by the control 306.

The control 306 provides the control function for operating the infrared light source 104. The control 306 may include a microprocessor or other suitable hardware for controlling the infrared light source 104. The control 306 may, for example, turn the infrared light source 104 on and off, adjust the intensity of the infrared light, adjust the output voltage of the DC-DC converter 304, and provide other functions for the infrared light source 104.

The infrared light source 104 may also include one or more drivers 308. The drivers 308 may include one or more switching components (such as MOSFETs, BJTs, or others), resistors, and other components. The drivers 308 may control the rate at which laser diodes 210 in the laser diode array 310 are switched on and off. In one embodiment, the drivers switch the laser diodes 210 at a rate of 10 k Hz. Each driver 308 may be associated with one or more laser diodes 210.

In one embodiment, the drivers 308 all switch the laser diodes 210 associated with the individual drivers 308 at a rate of 10 k Hz. The drivers 308 may, however, be intentionally placed out of phase with one another. This may, for example, allow the infrared light source 104 to appear as if it is operating at an overall switching rate of 80 k Hz, when in fact the individual laser diodes 210 are switching at a rate of 10 k Hz.

The infrared light source 104 may also include a laser diode array 310. The laser diode array 310 may include one or more laser diodes 210 that are controlled by the drivers 308. The laser diodes 210 may be selected to provide infrared light when the laser diodes 210 are activated.

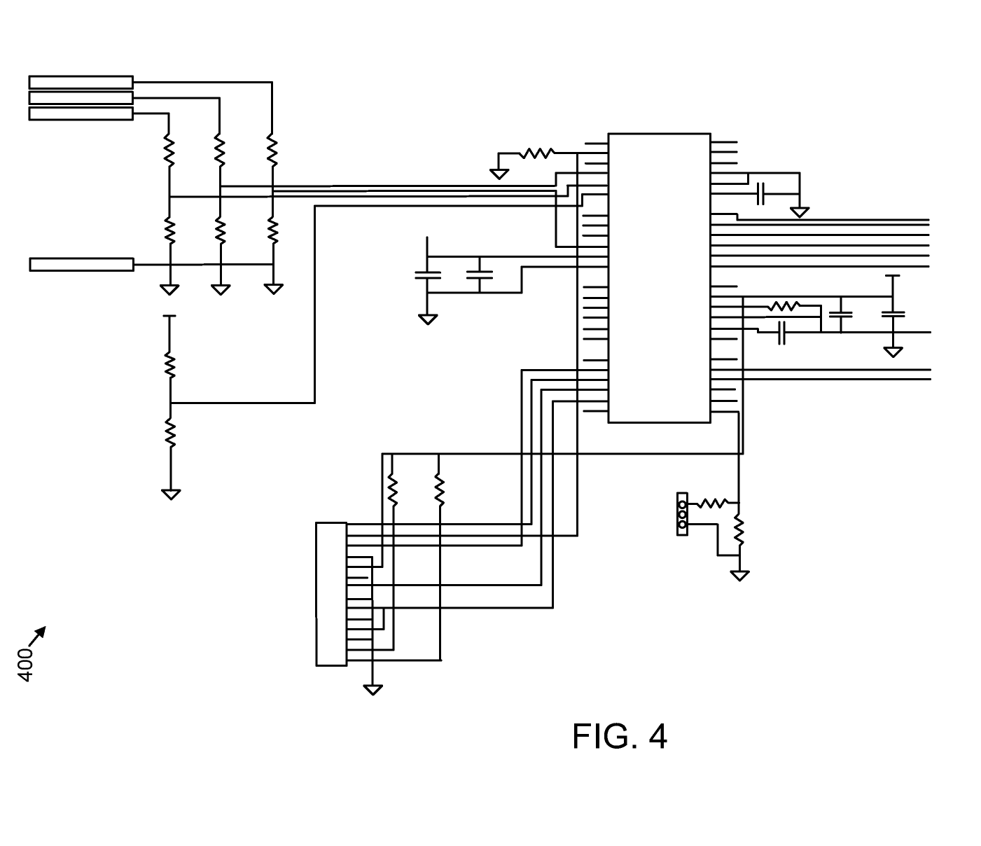

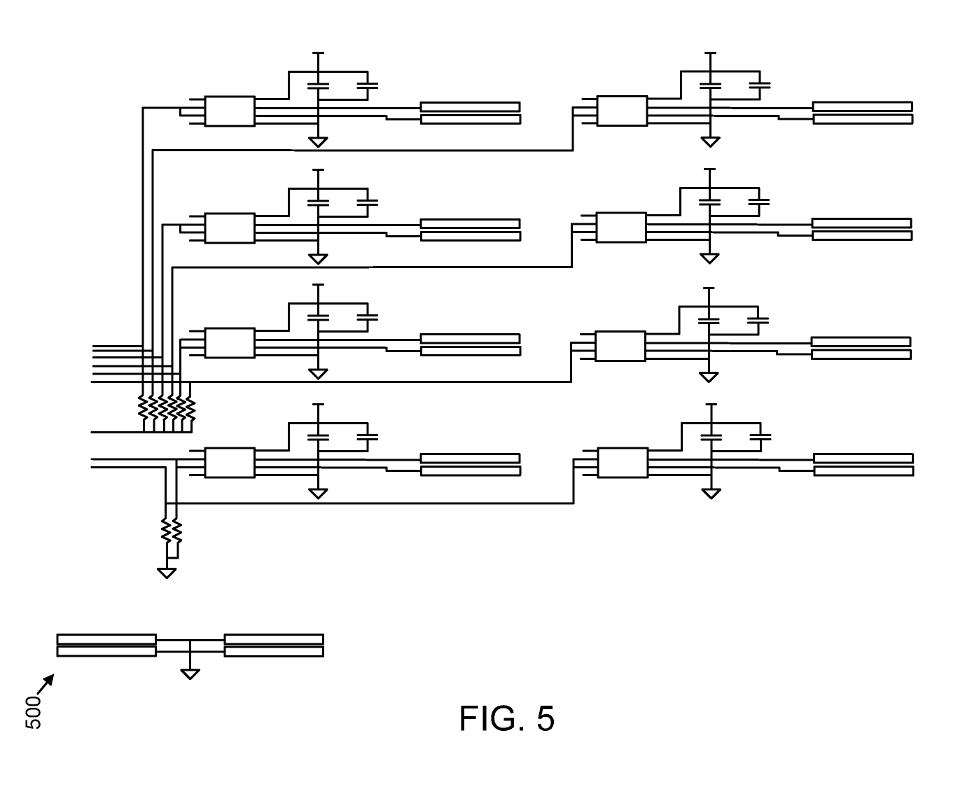

FIGS. 4 and 5 shows one embodiment of a drive circuit 400, 500 that can be used to drive signals for laser diodes 210. The circuit shown in FIGS. 4 and 5 may use an external control signal and monitored internal voltages to turn the drive signals on and off.

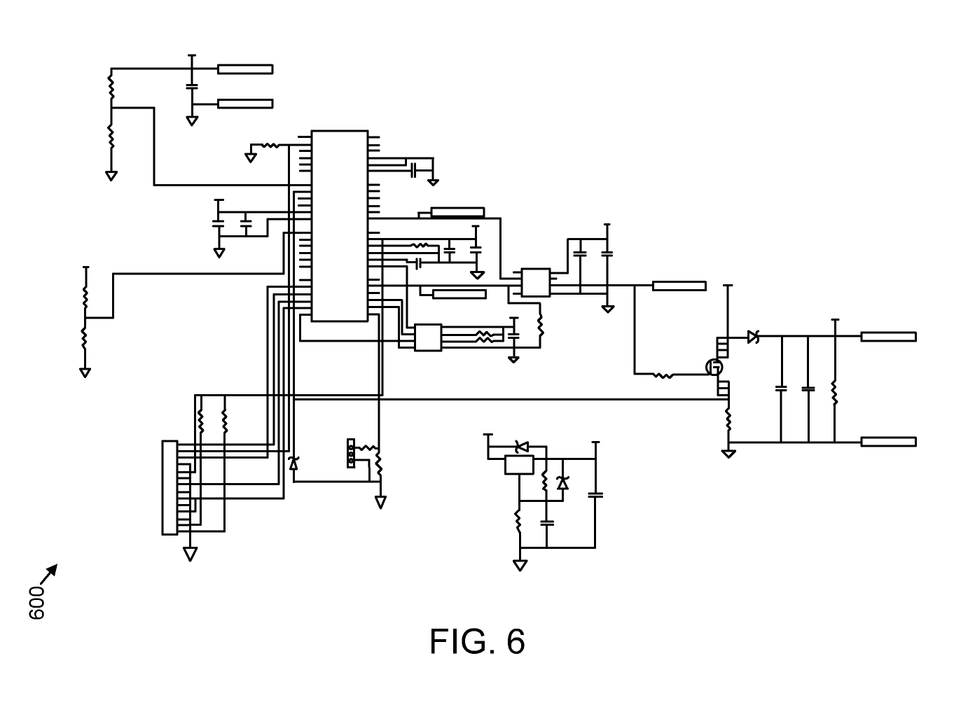

FIG. 6 shows one embodiment 600 of a digitally controlled DC-DC converter 304 that is controlled using an external control signal. The external control signal may be used to adjust the laser diode 210 voltage, and to control the output light level. FIG. 6 also shows a battery pack 302 and a linear regulator that is used to provide power and additional voltages that may be required by the infrared light source 104. FIG. 6 also shows a memory chip, which may be used to record data that is recorded during testing and operation.

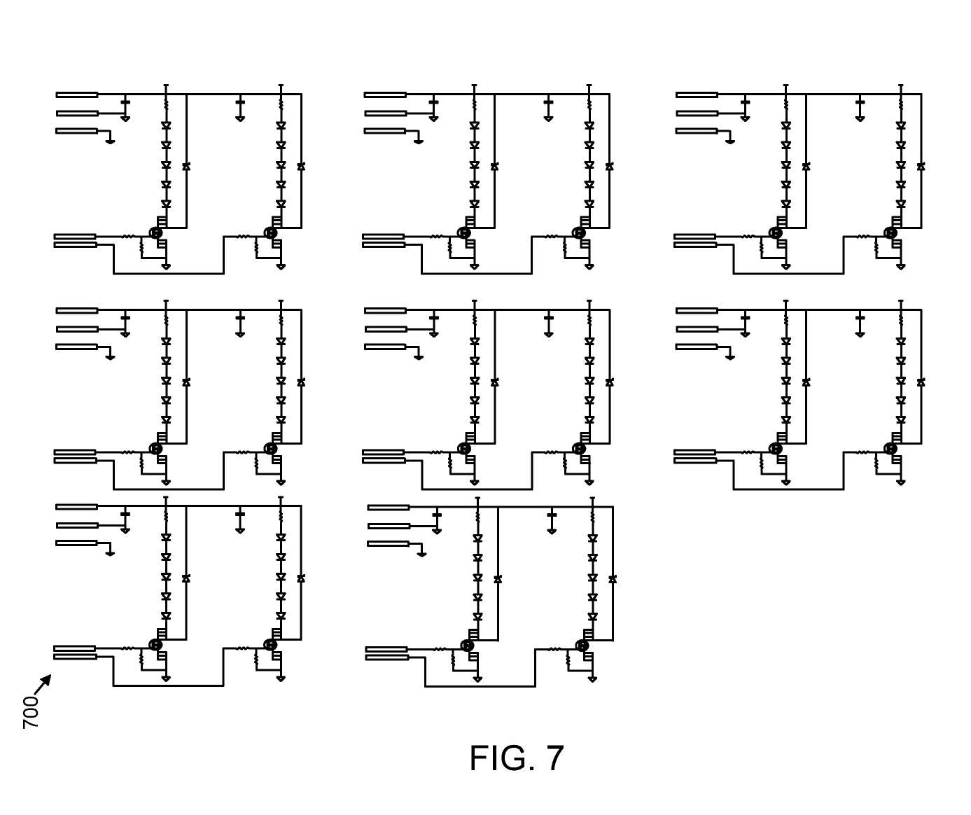

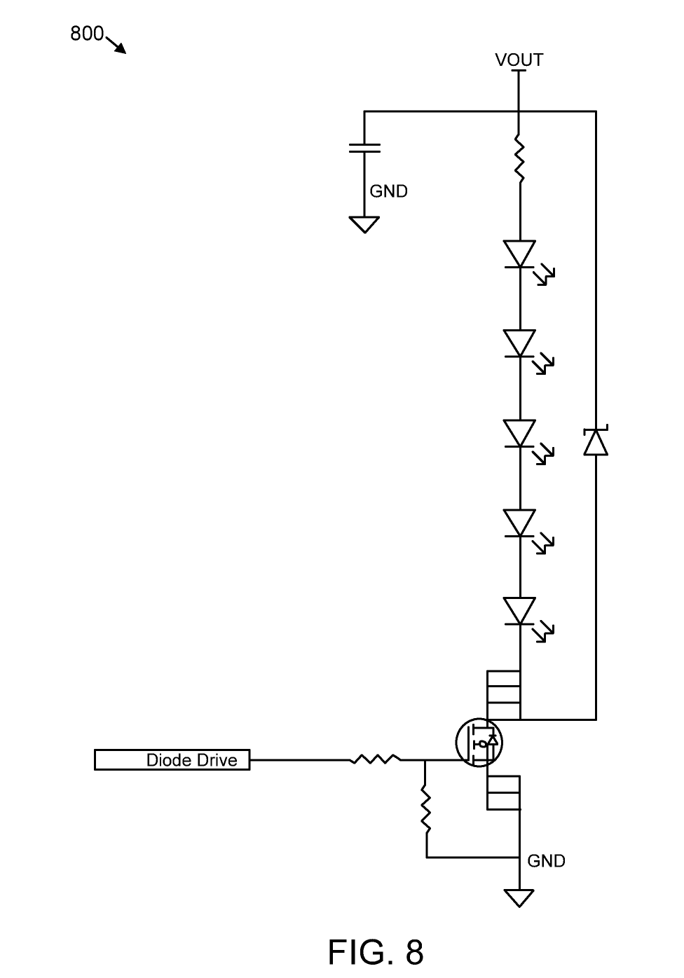

FIG. 7 shows one embodiment 700 of an array of laser diode 210 sets. As explained above, the different sets of laser diodes 210 may be turned on at different times. Each set of laser diodes 210 may operate at the same frequency, but they may be offset from one another such that they are turned on at different times. FIG. 8 shows one example 800 of an individual laser diode 210 set.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes,” “has,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus comprising:
an unmanned aerial system capable of sustained periods of flight;
an infrared light source coupled to the unmanned aerial system by attachment means, wherein the infrared light source comprises a plurality of laser diodes arranged in a pattern; and
a remote control configured to control one or more of the movements of the unmanned aerial system and the position of the infrared light source.

2. The apparatus of claim 1, wherein the infrared light source provides one or more of light within the near infrared portion of the infrared spectrum and light within the mid infrared portion of the infrared spectrum.

3. The apparatus of claim 1, wherein the remote control adjusts one or more of the intensity and beam width of the infrared light source and is capable of turning the infrared light source on and off.

4. The apparatus of claim 1, wherein the infrared light source further comprises a control signal configured to receive, translate, and transmit one or more signals from the remote control to the infrared light source control.

5. The apparatus of claim 1, wherein subsets of the plurality of laser diodes are configured to alternately turn on and off such that the infrared light source processes more than one phase change.

6. The apparatus of claim 5, wherein the phase change of the infrared light source is controlled by at least one driver, wherein each driver of the at least one drivers controls at least one laser diode.

7. The apparatus of claim 1, further comprising a battery pack configured to provide power to the infrared light source, wherein the battery pack provides a regulated direct current (“DC”) output.

8. The apparatus of claim 7, wherein the infrared light source further comprises a DC to DC converter, wherein the DC to DC converter receives a DC voltage from the battery pack and provides a regulated DC voltage to the infrared light source control.

9. A system comprising:
an unmanned aerial system capable of sustained periods of flight;
an infrared light source coupled to the unmanned aerial system by attachment means, wherein the infrared light source comprises a plurality of laser diodes arranged in a pattern;
a remote control configured to control one or more of the movements of the unmanned aerial system and the position of the infrared lights source; and
a battery pack configured to provide a regulated DC output.

10. The system of claim 9, wherein the infrared light source includes a DC to DC converter, wherein the DC to DC converter receives a DC voltage from the battery pack and provides a regulated DC voltage to the infrared light source control.

11. The system of claim 9, wherein subsets of the plurality of laser diodes are configured to alternately turn on and off such that the infrared light source processes more than one phase change.

12. The system of claim 11, wherein the phase change of the infrared light source is controlled by at least one driver, wherein each driver of the at least one drivers controls at least one laser diode.

13. The system of claim 9, wherein the infrared light source provides one or more of light within the near infrared portion of the infrared spectrum and light within the mid infrared portion of the infrared spectrum.

14. The system of claim 9, wherein the remote control adjusts one or more of the intensity and beam width of the infrared light source and is capable of turning the infrared light on and off.

15. The system of claim 9, wherein the infrared light source further comprises a control signal configured to receive, translate, and transmit one or more signals from the remote control to the infrared light source control.

16. A method comprising:
providing an unmanned aerial system capable of sustained periods of flight;
coupling an infrared light source to the unmanned aerial system by attachment means; and
controlling one or more of the movements of the unmanned aerial system and the position of the infrared light source using a remote control.

17. The method of claim 16, further comprising providing a battery pack configured to provide power to the infrared light source, wherein the battery pack provides a regulated direct current (“DC”) output.

18. The method of claim 17, further comprising using a DC to DC converter to receive a DC voltage from the batter pack and provide a regulated DC voltage to the infrared light source control.

19. The method of claim 16, wherein the infrared light source provides one or more of light within the near infrared portion of the infrared spectrum and light within the mid infrared portion of the infrared spectrum.

20. The method of claim 16, wherein the remote control adjusts one or more of the intensity and beam width of the infrared light source and is capable of turning the infrared light on and off.
